(19) United States
(12) Patent Application Publication
(10) Pub. No.: US 2022/0221809 A1
(43) Pub. Date: Jul. 14, 2022

(54) POWDER TRANSPORT DEVICE, DEVELOPING DEVICE, AND IMAGE FORMING APPARATUS

(71) Applicant: FUJIFILM Business Innovation Corp., Tokyo (JP)

(72) Inventors: Hirokazu ICHIHARA, Kanagawa (JP); Hirohisa HOSHINO, Kanagawa (JP); Suguru MATSUNAE, Kanagawa (JP); Taichi YAMADA, Kanagawa (JP)

(73) Assignee: FUJIFILM Business Innovation Corp., Tokyo (JP)

(21) Appl. No.: 17/370,085

(22) Filed: Jul. 8, 2021

(30) Foreign Application Priority Data
Jan. 12, 2021 (JP) 2021-002814

(51) Int. Cl. G03G 15/08

(52) U.S. Cl. CPC G03G 15/0872; G03G 15/0891

(57) ABSTRACT

A powder transport device includes: a storage part that stores powder; a transport member disposed in the storage part, the transport member extending in an axial direction and rotating to transport the powder in the storage part in the axial direction; and a swing member supported by the transport member so as to be rotated by the rotation of the transport member, the swing member swinging in a direction different from the axial direction while rotating.

### CROSS-REFERENCE TO RELATED APPLICATIONS

This application is based on and claims priority under 35 USC 119 from Japanese Patent Application No. 2021-002814 filed Jan. 12, 2021.

### BACKGROUND

### (i) Technical Field

The present disclosure relates to a powder transport device, a developing device, and an image forming apparatus.

### (ii) Related Art

Developing devices that develop electrostatic latent images with toner may experience lowering of toner transport force due to aggregation of toner.

Japanese Unexamined Patent Application Publication No. 2009-276631 discloses a structure in which a flattening member for flattening toner is provided near a toner entry port to prevent clogging of the toner.

Japanese Unexamined Patent Application Publication No. 2015-184310 discloses a structure in which a helical coil and a helical screw that is coaxial with the helical coil and has a larger pitch than the helical coil are disposed in a downward-sloping transport hose in which toner fall by gravity. With this structure, the helical screw inhibits the toner from moving through the helical coil, thus preventing solidification of the toner.

### SUMMARY

Aspects of non-limiting embodiments of the present disclosure relate to reducing adhesion of powder to a transport member or a storage part for powder, such as toner, compared with a case where a swing member is not disposed in the storage part.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a powder transport device including: a storage part that stores powder; a transport member disposed in the storage part, the transport member extending in an axial direction and rotating to transport the powder in the storage part in the axial direction; and a swing member supported by the transport member so as to be rotated by the rotation of the transport member, the swing member swinging in a direction different from the axial direction while rotating.

### BRIEF DESCRIPTION OF THE DRAWINGS

Exemplary embodiments of the present disclosure will be described in detail based on the following figures, wherein:

FIG. 1 schematically shows the structure of an image forming apparatus according to an exemplary embodiment of the present disclosure;

FIG. 2 is a plan view of a developing device;

FIG. 3 is a sectional view taken along line III-III in FIG. 2;

FIG. 4 shows the internal structure of the developing device;

FIG. 5 is an enlarged perspective vertical-sectional view of a portion near a toner supply port in a second chamber, indicated by circle V, VI in FIG. 4; and

FIG. 6 is an enlarged perspective vertical-sectional view of the same portion as in FIG. 5, at a point in time during swinging of a swing member.

### DETAILED DESCRIPTION

An exemplary embodiment of the present disclosure will be described below.

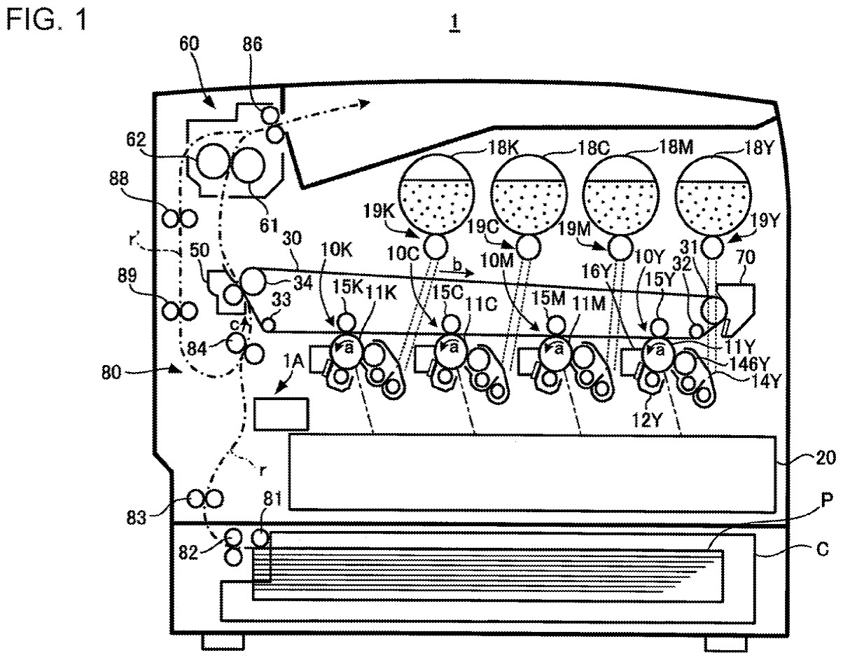

FIG. 1 schematically shows the structure of an image forming apparatus 1, serving as an exemplary embodiment of the present disclosure. The image forming apparatus 1 includes a developing device and a powder transport device, serving as exemplary embodiments of the present disclosure.

The image forming apparatus 1 shown in FIG. 1 is a tandem color printer in which image forming units 10Y, 10M, 10C, and 10K, corresponding to yellow (Y), magenta (M), cyan (C), and black (K), are arranged in parallel. The image forming apparatus 1 can print not only monochrome images, but also full-color images that are formed of toner images of four colors.

The image forming apparatus 1 includes: an exposure device 20 that irradiates each of the image forming units 10Y, 10M, 10C, and 10K with exposure light; an intermediate transfer belt 30 to which toner images are transferred from the image forming units 10Y, 10M, 10C, and 10K corresponding to the respective colors; a second transfer device 50 that transfers the toner images from the intermediate transfer belt 30 to a sheet; a fixing device 60 that fixes the toner images to the sheet; a belt cleaner 70 that recovers the toner from the intermediate transfer belt 30; a sheet transport part 80 that transports the sheet; and a sheet container C that stores sheets P. The image forming apparatus 1 also includes: toner containers 18Y, 18M, 18C, and 18K that store toners of the respective colors Y, M, C, and K; and toner supply devices 19Y, 19M, 19C, and 19K that supply the toners in the toner containers 18Y, 18M, 18C, and 18K to the image forming units 10Y, 10M, 10C, and 10K, respectively.

Herein, the toner containers 18Y, 18M, 18C, and 18K are replaceable cartridge-type containers. When any of the toner containers 18Y, 18M, 18C, and 18K becomes empty, that container is replaced with a new container. Hence, before the toner containers become empty, new toner containers for replacement are prepared and stored until those in use become empty. At this time, if the toner containers are stored in a high-temperature environment, the surface of the toner in the containers could become half-melted.

The four image forming units 10Y, 10M, 10C, and 10K have substantially the same structure. Hence, the image forming unit 10Y corresponding to yellow will be described as a representative example. The image forming unit 10Y includes an image carrier 11Y, a charger 12Y, a developing device 14Y, a first transfer device 15Y, and an image-carrier cleaner 16Y. The image carrier 11Y has a cylindrical surface and is rotated in the direction of arrow a, which is the axial direction of the cylinder, with an image formed on the surface thereof.

The charger 12Y includes a charging roller 121Y, which rotates while being in contact with the image carrier 11Y, and charges the surface of the image carrier 11Y.

The developing device 14Y stores developer containing toner and magnetic carrier. The developing device 14Y includes a developing roller 146Y. The developing roller 146Y transports the developer to a position facing the image carrier 11Y. Then, the toner in the developer is adhered to the image carrier 11Y, forming a toner image on the image carrier 11Y. When the amount of toner in the developing device 14Y has decreased, the toner in the toner container 18Y is supplied to the developing device 14Y by the toner supply device 19Y. The toner supply device 19Y accommodates a toner transport mechanism (not shown) that is driven under the control of a controller 1A.

The first transfer device 15Y transfers the toner image formed on the image carrier 11Y to the intermediate transfer belt 30. The image-carrier cleaner 16Y cleans the surface of the image carrier 11Y after the transfer.

The exposure device 20 emits exposure light based on an externally supplied image signal to expose the image carriers 11Y, 11M, 11C, and 11K.

The intermediate transfer belt 30 is an endless belt-like member that is supported by belt support rollers 31, 32, 33, and 34 and runs in the direction of arrow b while passing through the image forming units 10Y, 10M, 10C, and 10K and the second transfer device 50. The intermediate transfer belt 30 carries color toner images formed by the image forming units 10Y, 10M, 10C, and 10K.

The second transfer device 50 includes a roller opposed to the backup roller 34, which is one of the belt support rollers 31 to 34, and rotating with the intermediate transfer belt 30 and a sheet therebetween. A voltage for generating a toner-transferring electric field is supplied between the second transfer device 50 and the backup roller 34, and the toner images on the intermediate transfer belt 30 are transferred to the sheet.

The belt cleaner 70 removes the toner remaining on the intermediate transfer belt 30 with a blade 71 that is in contact with the intermediate transfer belt 30.

The fixing device 60 includes a heating roller 61 and a pressure roller 62. By allowing a sheet with an unfixed toner images to pass between the heating roller 61 and the pressure roller 62, the fixing device 60 fixes the toner images to the sheet.

The sheet transport part 80 picks a sheet P from the sheet container C and transports the sheet P along a sheet transport path r extending through the second transfer device 50 and the fixing device 60. The sheet transport part 80 includes a pickup roller 81 that picks a sheet P stored in the sheet container C, separation rollers 82 that separate the sheet P from the remaining sheets, transport rollers 83 that transport the sheet P, registration rollers 84 that transport the sheet P to the second transfer device 50, discharging rollers 86 that discharge the sheet P to the outside, and reversing transport rollers 88 and 89 that transport the sheet P in duplex printing.

The basic operation of the image forming apparatus 1 shown in FIG. 1 will be described. In the image forming unit 10Y corresponding to yellow, the image carrier 11Y is rotated in the direction of arrow a, and the charger 12Y charges the surface of the image carrier 11Y. This structure is common to the image forming units 10M, 10C, and 10K corresponding to the other colors. The exposure device 20 irradiates the image carrier 11Y, 11M, 11C, and 11K with exposure light based on data corresponding to the respective colors in an image signal. Formation of a yellow (Y) image will be described as an example. The exposure device 20 irradiates the surface of the image carrier 11Y with exposure light based on an image signal corresponding to yellow in an externally supplied image signal to form an electrostatic latent image on the surface of the image carrier 11Y. The developing device 14Y develops the electrostatic latent image with the yellow toner to form a toner image. The toner supply device 19Y supplies the toner to the developing device 14Y from the toner container 18Y. The image carrier 11Y rotates with a yellow toner image formed on the surface thereof. The toner image formed on the surface of the image carrier 11Y is transferred to the intermediate transfer belt 30 by the first transfer device 15Y, which applies a transfer electric potential between the surface of the image carrier 11Y and the intermediate transfer belt 30. The toner remaining on the image carrier 11Y after the transfer is removed and recovered by the image-carrier cleaner 16Y.

The intermediate transfer belt 30 is supported by the support rollers 31 to 34 and runs in the direction of arrow b. The image forming units 10M, 10C, and 10K corresponding to the other colors form magenta, cyan, and black toner images, respectively, in the same way as the image forming unit 10Y and transfer the toner images to the intermediate transfer belt 30 so as to be superimposed on the toner image transferred by the image forming unit 10Y. Meanwhile, a sheet P in the sheet container C is picked by the pickup roller 81 and is transported in the direction of arrow c, toward the second transfer device 50, along the sheet transport path r by the separation rollers 82, the transport rollers 83, and the registration rollers 84. The sheet P is fed to the second transfer device 50 by the registration rollers 84 in accordance with the timing when the toner images are transferred to the intermediate transfer belt 30. The second transfer device 50 transfers the toner images on the intermediate transfer belt 30 to the sheet P by applying a transfer bias electric potential between the intermediate transfer belt 30 and the sheet P. The sheet P, to which the toner images have been transferred by the second transfer device 50, is transported to the fixing device 60, where the toner images transferred to the sheet P are fixed to the sheet P. In this way, an image is formed on the sheet P. The sheet P with an image formed thereon is discharged from the discharge port 87 to the upper part of the image forming apparatus 1 by the discharging rollers 86. The toner remaining on the intermediate transfer belt 30 after the transfer by the second transfer device 50 is removed by the belt cleaner 70.

In duplex printing, in which an image is formed also on the back of the side with an image, the discharging rollers 86 discharge the sheet P from the discharge port 87 halfway and then transport the sheet P in the reverse direction. The sheet P transported in the reverse direction is transported along a reversing transport path r′ by the reversing transport rollers 88 and 89. The sheet P passes through the registration rollers 84 and is fed to the second transfer device 50 in a reversed state, where an image is formed on the back.

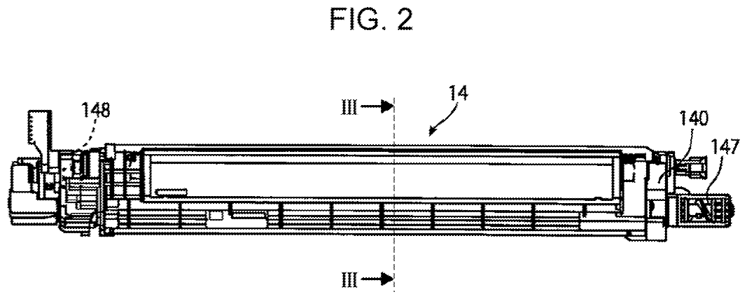

FIG. 2 is a plan view of the developing device 14.

The image forming apparatus 1 shown in FIG. 1 includes four developing devices, 14Y, 14M, 14C, and 14K having substantially the same structure. Hence, in the description below and the drawings after FIG. 2, the reference signs Y, M, C, and K representing the colors of toner are omitted, and the developing devices 14Y, 14M, 14C, and 14K will be simply called the developing devices 14. Components of the developing devices 14 are also mentioned without the reference signs Y, M, C, or K. Similarly, components of devices other than the developing devices 14 in FIG. 1 are also described without the reference signs Y, M, C, or K.

FIG. 2 shows the top surface of the developing device 14. A housing 140 of the developing device 14 has a toner supply port 147 in the upper part thereof. The housing 140 of the developing device 14 also has a developer discharge port 148 in the lower part thereof. The position of the developer discharge port 148 is indicated by a dashed-line rectangle.

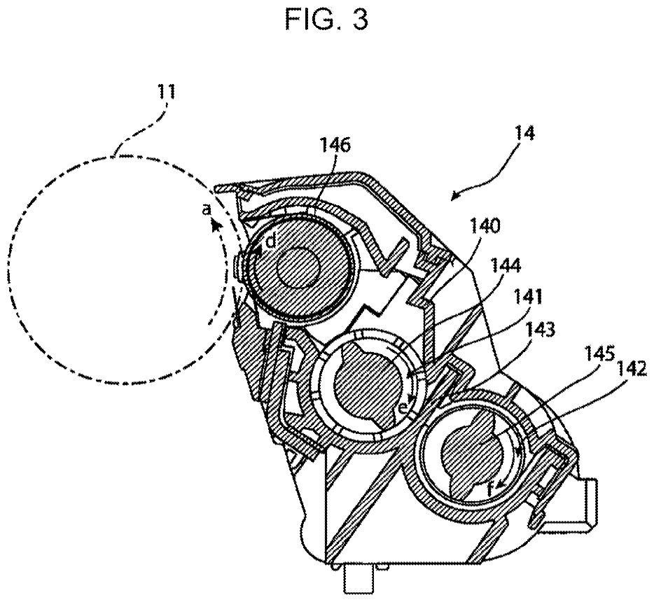

FIG. 3 is a sectional view taken along line III-III in FIG. 2.

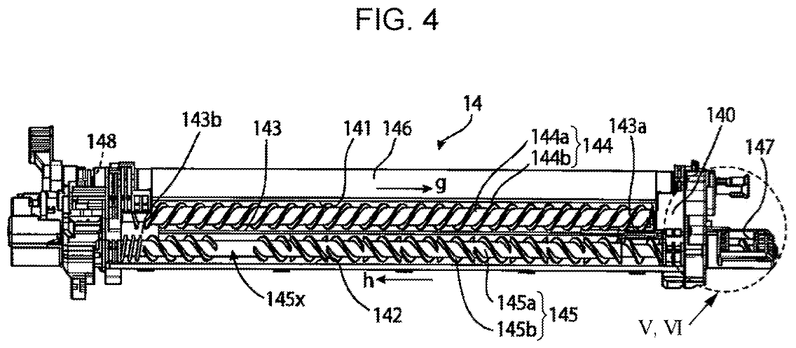

FIG. 4 shows the internal structure of the developing device 14.

The developing device 14 has two developer storage chambers, namely, a first chamber 141 and a second chamber 142, in the housing 140. The two storage chambers (the first chamber 141 and the second chamber 142) are divided by a partition wall 143. The first chamber 141 accommodates a supply auger 144, and the second chamber 142 accommodates an admix auger 145. The supply auger 144 and the admix auger 145 are rod-like members, and rotation shafts 144a and 145a thereof are arranged substantially horizontally and substantially parallel to each other. The supply auger 144 has the rotation shaft 144a with a circular section and a helical blade 144b wound therearound in a helical manner so as to extend along the rotation shaft 144a. Similarly to the supply auger 144, the admix auger 145 has the rotation shaft 145a with a circular section and a helical blade 145b wound therearound in a helical manner so as to extend along the rotation shaft 145a. The admix auger 145 has a portion 145x where the helical blade 145b is not formed. The developing device 14 has, at a position corresponding to the portion 145x where the helical blade 145b is not formed, a sensor (not shown) that detects the toner density (the ratio of toner to carrier) in the developer in the developing device 14. By providing the portion 145x, where the helical blade 145b is not formed, in the admix auger 145, interference between the sensor and the helical blade 145b is avoided.

The supply auger 144 and the admix auger 145 rotate in the same direction, as shown by arrows e and f in FIG. 3. The helical blade 144b of the supply auger 144 and the helical blade 145b of the admix auger 145 rotate in the opposite directions. When the supply auger 144 and the admix auger 145 rotate in the same direction (the directions shown by arrows e and f), the developer in the first chamber 141 and the second chamber 142 is transported in the opposite directions while being stirred. Specifically, the developer in the first chamber 141, which accommodates the supply auger 144, is transported in the direction of arrow g, and the developer in the second chamber 142, which accommodates the admix auger 145, is transported in the direction of arrow h.

The partition wall 143 between the first chamber 141 and the second chamber 142 has a first window 143a and a second window 143b at the ends thereof, via which the first chamber 141 and the second chamber 142 communicate with each other. Hence, the developer transported in the direction of arrow g in the first chamber 141 enters the second chamber 142 through the first window 143a, and the developer transported in the direction of arrow h in the second chamber 142 enters the first chamber 142 through the second window 143b. In this manner, the developer in the developing device 14 circulates between the first chamber 141 and the second chamber 142 while being stirred. Of the supply auger 144 and the admix auger 145, the admix auger 145 is an example of a transport member in the present disclosure. The second chamber 142 accommodating the admix auger 145 is an example of a storage part in the present disclosure.

The developing device 14 also has a developing roller 146 near the first chamber 141 accommodating the supply auger 144. A portion of the developing roller 146 is exposed from the housing 140. The developing device 14 is set in the image forming apparatus 1 (see FIG. 1) such that the exposed portion of the developing roller 146 is near the image carrier 11.

The developing roller 146 rotates in the direction of arrow d while magnetically attracting the developer in the first chamber 141 to the surface thereof to transport the developer to the position facing the image carrier 11. As a result, an electrostatic latent image formed on the surface of the image carrier 11 is developed with the toner in the developer, and thus, a toner image is formed on the surface of the image carrier 11. After developing the image with the toner, the developer on the surface of the developing roller 146 returns to the inside of the housing 140 as the developing roller 146 rotates, is separated from the developing roller 146, and is circulated with the remaining developer in the first chamber 141 while being stirred.

As the development with the toner is repeated, the amount of toner in the developer stored in the developing device 14 decreases. Hence, the developing device 14 has the toner supply port 147, through which the toner in the toner container 18, as shown in FIG. 1, is supplied to the developing device 14 by the toner supply device 19. As shown in FIG. 4, the toner supply port 147 is provided upstream (i.e., on the side opposite to the direction indicated by arrow h) of the first window 143a in the second chamber 142 accommodating the admix auger 145. The admix auger 145 extends to the position of the toner supply port 147. The shape of the portion of the helical blade 145b extending to the position of the toner supply port 147 is different from the shape of the portion of the helical blade 145b extending beside the supply auger 144. The toner supplied from the toner supply port 147 is transported downstream (i.e., in the direction of arrow h) through the second chamber 142 by the admix auger 145, is merged with the developer entering through the first window 143a, and is transported further downstream (i.e., in the direction of arrow h) through the second chamber 142.

The developing device 14 has, in the bottom surface thereof, a developer discharge port 148 through which the developer in the developing device 14 is gradually discharged. The developer in the developing device 14 is gradually discharged from the developer discharge port 148 to prevent excessive progress of deterioration of the developer in the developing device 14 due to stirring and transporting. Not only the toner, but also the carrier is discharged from the developer discharge port 148. Hence, the toner in the toner container 18 (see FIG. 1) to be supplied through the toner supply port 147 contains a small amount of carrier to compensate for the decrease of the carrier.

The developer discharged from the developing device 14 through the developer discharge port 148 is stored in a waste toner tank (not shown) through a waste-toner discharge path (not shown).

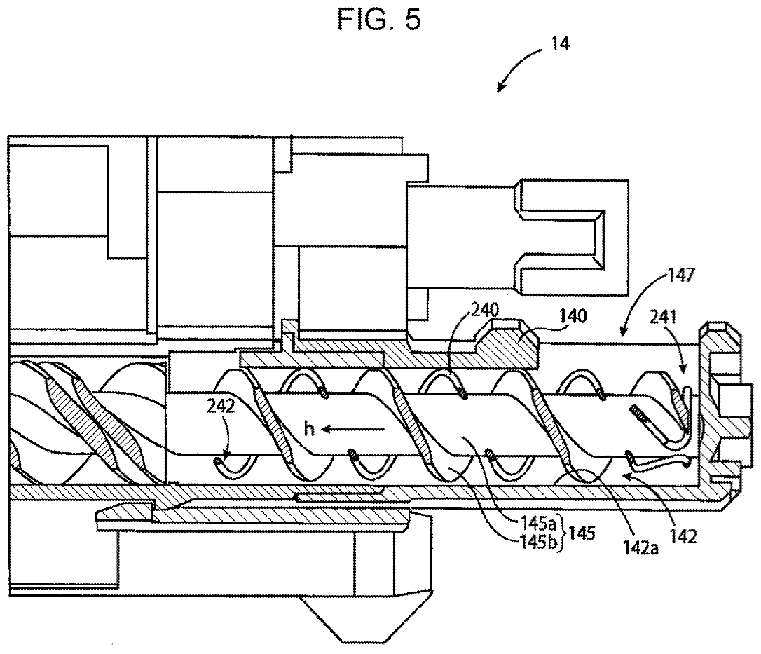

FIG. 5 is an enlarged perspective vertical-sectional view of a portion near the toner supply port 147 in the second chamber 142, shown by circle V, VI in FIG. 4.

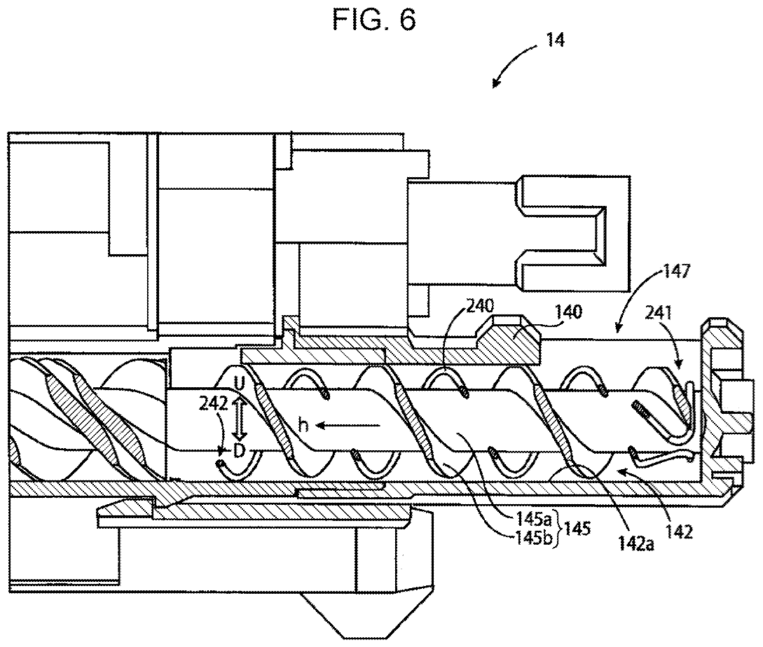

FIG. 6 is an enlarged perspective vertical-sectional view of the same portion as in FIG. 5, at a point in time during swinging of a swing member.

FIG. 5 shows an end of the admix auger 145 near the toner supply port 147.

The admix auger 145 is supported by a housing 141 of the developing device 14 in a manner capable of rotation.

Furthermore, a swing member 240 is disposed in the second chamber 142, at a portion near the toner supply port 147. The toner supply port 147 is an example of an inlet according to the present disclosure.

When the amount of toner in the developing device 14 becomes smaller than a certain level, the toner in the toner container 18 is transported by the toner supply device 19 and is supplied to the developing device 14 through the toner supply port 147. The toner supplied to the developing device 14 is transported in the direction of arrow h by the rotation of the admix auger 145. The toner supplied through the toner supply port 147 contains only a small amount of carrier. If toner with half-melted surface is supplied, the toner particles may aggregate together, adhere to and deposited on an inner wall 142a of the second chamber 142 and the admix auger 145, and consequently be fixed.

Herein, “adhere” means a state in which toner is in contact with a member, “deposit” means a state in which toner further adheres to the toner that has already adhered to the member, and “fix” means a state in which the bulk density of the deposited toner has increased, and the toner has become solid.

When the toner is fixed to the inner wall 142a of the second chamber 142 or the admix auger 145, a gap between the admix auger 145 and the inner wall 142a of the second chamber 142, through which the toner is transported, becomes narrow, which lowers the transport capacity. This may further increase the bulk density of the toner and cause deposition and fixing of the toner, inhibiting proper transport.

To avoid this problem, the developing device 14 has the swing member 240, which flattens the toner that has started to solidify, to prevent deposition of the toner.

The swing member 240 is disposed at a position at least partially facing the toner supply port 147. Because the swing member 240 is disposed at such a position, adhesion of the toner near the toner supply port 147 is reduced, compared with a case where the swing member 240 is disposed at a position not facing the toner supply port 147.

The length of the swing member 240 in the direction parallel to the rotation shaft 145a of the admix auger 145 is smaller than the admix auger 145. Hence, aggregation of toner near the toner supply port 147, where the carrier density is low, and thus, aggregation of toner is likely to occur, is efficiently prevented.

The swing member 240 is supported by the admix auger 145 so as to be rotated by the rotation of the admix auger 145 and swings in a direction different from the direction in which the rotation shaft 145a of the admix auger 145 extends. More specifically, the swing member 240 according to this exemplary embodiment is a coil-like member having the same helical pitch as the helical blade 145b of the admix auger 145. A wire of the coil is wound around the rotation shaft 45a in a helical manner so as to be located between adjoining turns of the helical blade 145b when the rotation shaft 145a is viewed in the axial direction. In this exemplary embodiment, the coil-like swing member 240 has substantially the same diameter as the helical blade 145a of the admix auger 145.

Because the swing member 240 according to this exemplary embodiment is a coil-like member, the swing member 240 contributes to transportation of the toner, compared with a case where the swing member 240 is, for example, a plate-like member. Furthermore, because the swing member 240 is wound around the rotation shaft 45a in a helical manner such that the wire of the coil is located between adjoining turns of the helical blade 145b, both aggregation of toner on the rotation shaft 145a of the admix auger 145 and aggregation of toner on the inner wall 142a of the second chamber 142 are prevented.

More specifically, the wire of the coil of the swing member 240 is disposed at a position between adjoining turns of the helical blade 145b in the axial direction and away from both of the adjoining turns of the helical blade 145b; that is, substantially in the middle between the adjoining turns of the helical blade 145b. Hence, compared with a case where the swing member 240 is located near one of the adjoining turns of the helical blade 145b, a transport performance close to that obtained when the admix auger 145 has a double helical blade is obtained.

One end 241 of the swing member 240 is supported by the admix auger 145, and the other end 242 of the swing member 240 is a free end that can swing freely. Hence, the other end 242 (free end) swings in the directions of arrows U and D, as shown in FIG. 6, which are different from the direction in which the rotation shaft 145a of the admix auger 145 extends. Because the other end 242 of the swing member 240 is a free end that can swing freely, the swing member 240 can swing by a large degree, compared with a case where both ends of the swing member 240 are supported by the admix auger 145. This structure prevents both fixing of toner to the rotation shaft 145a of the admix auger 145 and fixing of toner to the inner wall 142a of the second chamber 142.

More specifically, the one end 241 of the swing member 240 according to this exemplary embodiment is supported by the admix auger 145 with a certain allowance so as to allow swinging of the other end 242. When the one end 241 is supported with a certain allowance, the other end 242 can swing more freely, compared with a case where the one end 241 is fixed to the admix auger 145.

FIG. 6 shows the swing member 240 in a state in which the other end 242 (free end) has swung in the direction of arrow D and is in contact with the inner wall 142a of the second chamber 142.

In this exemplary embodiment, because the swing member 240 is provided, aggregation of toner near the toner supply port 147 is prevented, and consequently, a decrease in the toner transport force is prevented.

Although the swing member 240 is disposed at a position at least partially facing the toner inlet 147 in this exemplary embodiment, the swing member 240 may be disposed at any position where aggregation of toner could occur.

Furthermore, although an example case has been described in which the present disclosure is applied to the developing device 14 used in the image forming apparatus 1, which is a so-called tandem image forming apparatus, as shown in FIG. 1, the present disclosure may be applied to various types of image forming apparatuses, such as monochrome printers, besides the image forming apparatus of the type shown in FIG. 1.

Furthermore, although an example case in which the swing member 240 is provided in the developing device 14 has been described, the swing member 240 may be provided in a device other than the developing device 14, such as a waste-toner recovery device (not shown) that transports the developer discharged through the developer discharge port 148 toward a waste toner tank (not shown).

Furthermore, the present disclosure may be applied to a powder transport device that transports a powder other than toner.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A powder transport device comprising:
a storage part that stores powder;
a transport member disposed in the storage part, the transport member extending in an axial direction and rotating to transport the powder in the storage part in the axial direction; and
a swing member supported by the transport member so as to be rotated by the rotation of the transport member, the swing member swinging in a direction different from the axial direction while rotating.

2. The powder transport device according to claim 1, wherein
the storage part has an inlet through which the powder is introduced, and
the swing member is disposed at a position at least partially facing the inlet.

3. The powder transport device according to claim 1, wherein the swing member is shorter than the transport member in the axial direction.

4. The powder transport device according to claim 2, wherein the swing member is shorter than the transport member in the axial direction.

5. The powder transport device according to claim 1, wherein the swing member is a coil-like member having a wire.

6. The powder transport device according to claim 2, wherein the swing member is a coil-like member having a wire.

7. The powder transport device according to claim 3, wherein the swing member is a coil-like member having a wire.

8. The powder transport device according to claim 4, wherein the swing member is a coil-like member having a wire.

9. The powder transport device according to claim 5, wherein
the transport member includes a rotation shaft extending in the axial direction and a helical blade wound around the rotation shaft in a helical manner so as to extend in the axial direction, and
the wire of the swing member is wound around the rotation shaft in a helical manner so as to be located between adjoining turns of the helical blade in the axial direction.

10. The powder transport device according to claim 6, wherein
the transport member includes a rotation shaft extending in the axial direction and a helical blade wound around the rotation shaft in a helical manner so as to extend in the axial direction, and
the wire of the swing member is wound around the rotation shaft in a helical manner so as to be located between adjoining turns of the helical blade in the axial direction.

11. The powder transport device according to claim 7, wherein
the transport member includes a rotation shaft extending in the axial direction and a helical blade wound around the rotation shaft in a helical manner so as to extend in the axial direction, and
the wire of the swing member is wound around the rotation shaft in a helical manner so as to be located between adjoining turns of the helical blade in the axial direction.

12. The powder transport device according to claim 8, wherein
the transport member includes a rotation shaft extending in the axial direction and a helical blade wound around the rotation shaft in a helical manner so as to extend in the axial direction, and
the wire of the swing member is wound around the rotation shaft in a helical manner so as to be located between adjoining turns of the helical blade in the axial direction.

13. The powder transport device according to claim 9, wherein the wire of the swing member is located at a position between the adjoining turns of the helical blade in the axial direction and away from both of the adjoining turns of the helical blade.

14. The powder transport device according to claim 10, wherein the wire of the swing member is located at a position between the adjoining turns of the helical blade in the axial direction and away from both of the adjoining turns of the helical blade.

15. The powder transport device according to claim 11, wherein the wire of the swing member is located at a position between the adjoining turns of the helical blade in the axial direction and away from both of the adjoining turns of the helical blade.

16. The powder transport device according to claim 12, wherein the wire of the swing member is located at a position between the adjoining turns of the helical blade in the axial direction and away from both of the adjoining turns of the helical blade.

17. The powder transport device according to claim 9, wherein one end of the swing member in the axial direction is supported by the transport member with a certain allowance such that the other end of the swing member can swing.

18. The powder transport device according to claim 1, wherein one end of the swing member is supported by the transport member, and the other end of the swing member is a free end that can swing.

19. A developing device comprising:
a storage part that stores toner;
a transport member disposed in the storage part, the transport member extending in an axial direction and rotating to transport the toner in the storage part in the axial direction; and
a swing member supported by the transport member, the swing member swinging in a direction different from the axial direction while being rotated by the rotation of the transport member,
wherein the developing device develops, with the toner, an electrostatic latent image formed on an image carrier facing the developing device.

20. An image forming apparatus comprising the developing device according to claim 19, the image forming apparatus fixing, to a sheet, a toner image obtained by developing an electrostatic latent image with toner.
